(19) United States
(12) Patent Application Publication
(10) Pub. No.: US 2007/0039229 A1
(43) Pub. Date: Feb. 22, 2007

(54) Fishing rod

(76) Inventor: Hudson Wang, Feng-Shan City (TW)

Correspondence Address: FROMMER LAWRENCE & HAUG, 745 FIFTH AVENUE- 10TH FL., NEW YORK, NY, 10151, US

(21) Appl. No.: 11/207,294

(22) Filed: Aug. 19, 2005

(51) Int. Cl. A01K 87/00

(52) U.S. Cl. 43/18.1 R

(57) ABSTRACT

A fishing rod includes a hollow butt section and a solid tip section. The butt section has an inner surface that defines an inner space. The tip section has an inner segment that extends into the inner space and that is bonded adhesively to the inner surface of the butt section, and an outer segment that extends from the inner segment and that is disposed outwardly of the inner space.

### BACKGROUND OF THE INVENTION

1. Field of the Invention

The invention relates to a fishing rod, more particularly to a fishing rod that has a solid tip section capable of better withstanding bending forces.

2. Description of the Related Art

Conventional fishing rods can be categorized into two groups, where one is made from artificial fibers, while the other is made from natural materials, such as the Cantonese bamboo. Artificial fibers can be further categorized into combinations of fiberglass and carbon fibers, etc. However, due to the high cost and high selling price of fishing rods that are made from natural materials, fishing rods that are made from artificial fibers have become the main stream and are accepted by consumers.

When making fishing rods from artificial fibers, manufacturers make necessary adjustments to the composition of fiberglass or carbon fibers depending on the types of fishing rods, in order to take into consideration the quality as a whole, and structural characteristic requirements, such as action, bending recovery ability, elasticity, and tenacity. For example, in order to reduce the weight of fishing rods, the composition of carbon fibers usually ranges from 80% to 96%, whereas fiberglass is used to enhance the tenacity of the fishing rod as a whole.

FIG. 1 is a fragmentary view of a conventional fishing rod 1, which has a rod body 12 that is made from artificial fibers and that is hollow so as to be lightweight, and a rod tip 13 that is coupled to the rod body 12. However, due to structural limitations of artificial fibers, when the conventional fishing rod 1 is bent due to an external force, the rod tip 13 cannot withstand high shearing forces as well as that of a fishing rod made from natural materials, thereby increasing the likelihood for the rod tip 13 to fracture (anticipated and illustrated using dotted lines in the figure).

### SUMMARY OF THE INVENTION

Therefore, the object of the present invention is to improve upon conventional fishing rods that are made from artificial fibers, in particular, to provide a fishing rod with a solid tip section to increase the tenacity, bending smoothness, and elasticity of the fishing rod as a whole.

According to the present invention, there is provided a fishing rod that includes: a hollow butt section having an inner surface that defines an inner space; and a solid tip section having an inner segment that extends into the inner space and that is bonded adhesively to the inner surface of the butt section, and an outer segment that extends from the inner segment and that is disposed outwardly of the inner space.

### BRIEF DESCRIPTION OF THE DRAWINGS

Other features and advantages of the present invention will become apparent in the following detailed description of the preferred embodiments with reference to the accompanying drawings of which:

FIG. 1 is a fragmentary sectional view of a hollow rod body of a conventional fishing rod to illustrate fracturing of a tip section;

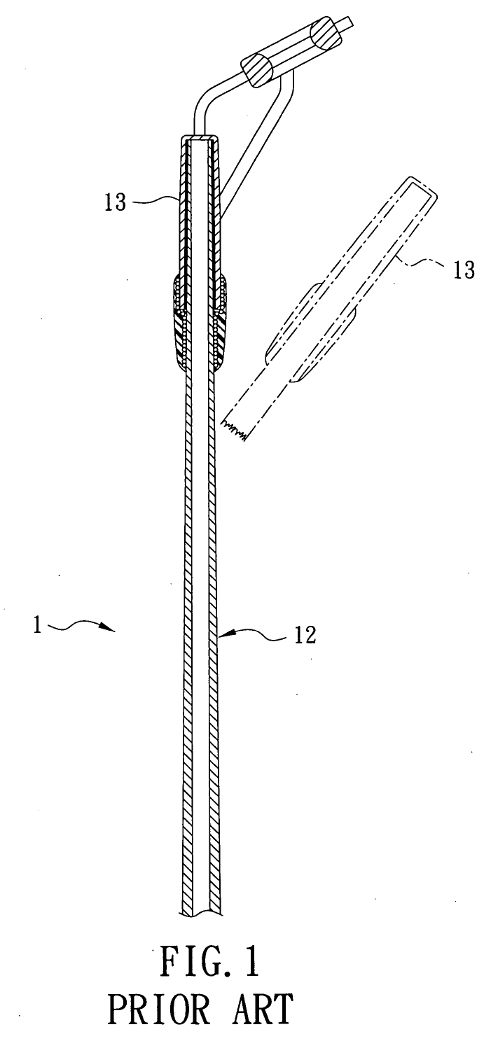

FIG. 2 is a fragmentary sectional view of the first preferred embodiment of a fishing rod according to the present invention; and

FIG. 3 is a fragmentary sectional view of the second preferred embodiment of a fishing rod according to the present invention.

### DETAILED DESCRIPTION OF THE PREFERRED EMBODIMENTS

Before the present invention is described in greater detail, it should be noted herein that like elements are denoted by the same reference numerals throughout the disclosure.

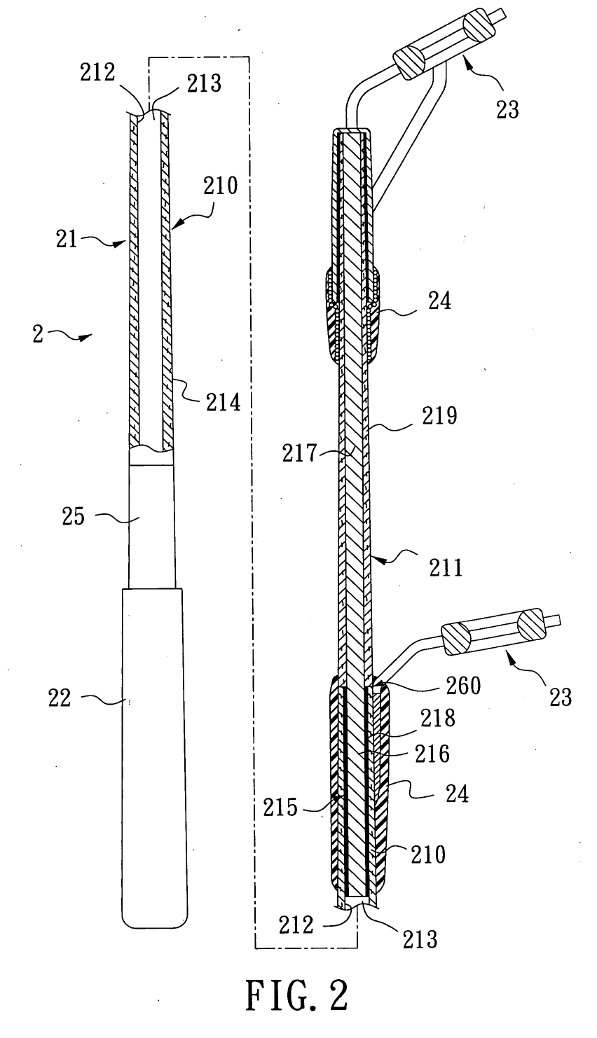

As shown in FIG. 2, the first preferred embodiment of a fishing rod 2 according to the present invention comprises a blank 21, a grip 22 that encircles and that is secured to a bottom portion of the blank 21, a plurality of line guides 23 disposed separately on the blank 21, a plurality of epoxy coatings 24 for bonding the line guides 23 to the blank 21, and a reel seat (not shown) disposed on a lower part 25 of the blank 21 that is adjacent to the grip 22.

The blank 21 includes a hollow butt section 210 that has the grip 22 sleeved securely thereon, and a solid tip section 211. The butt section 210 has an inner surface 212 that defines an inner space 213, an outer surface 214, and an end portion 215. The tip section 211 has an inner segment 216 that extends into the inner space 213 of the butt section 210 at the end portion 215, and that is bonded to the inner surface 212 of the butt section 210 at the end portion 215 with an adhesive 218, an outer segment 217 that extends from the inner segment 216, and that is disposed outwardly of the inner space 213, and a web 219 that is wound around the outer segment 217 of the tip section 211. In this preferred embodiment, the butt section 210 can be made from resin-impregnated carbon fibers or composite fibers.

With the winding of the web 219 around the outer segment 217, the juncture between the butt section 210 and the inner segment 216 of the tip section 211 is strengthened. In addition, the bending smoothness at the juncture between the butt section 210 and the outer segment 217 of the tip section 211 is also improved (this refers to the bending shape at the juncture). In this preferred embodiment, the inner segment 216 and the outer segment 217 are made from a titanium alloy, while the web 219 is made from composite fibers.

In the first preferred embodiment, there are two line guides 23, one of which is sleeved securely at a top of the tip section 211, while the other is sleeved securely at a junction 260 between the butt section 210 and the tip section 211. With the addition of the epoxy coating 24 over a portion of the latter line guide 23, the junction 260 can be strengthened.

It has thus been shown that due to the cooperation between the outer segment 217 and the web 219, the structure of the tip section 211 becomes sturdy and solid, as opposed to hollow for a conventional fishing rod, so that the rigidity, tenacity, and bending recovery ability of the tip section 211 are all enhanced, and the ability to withstand tensile forces and shear forces is also enhanced. Consequently, the drawback of a conventional fishing rod in its inability to withstand high shear forces due to a hollow rod body, which results in an easily fractured tip section, is improved.

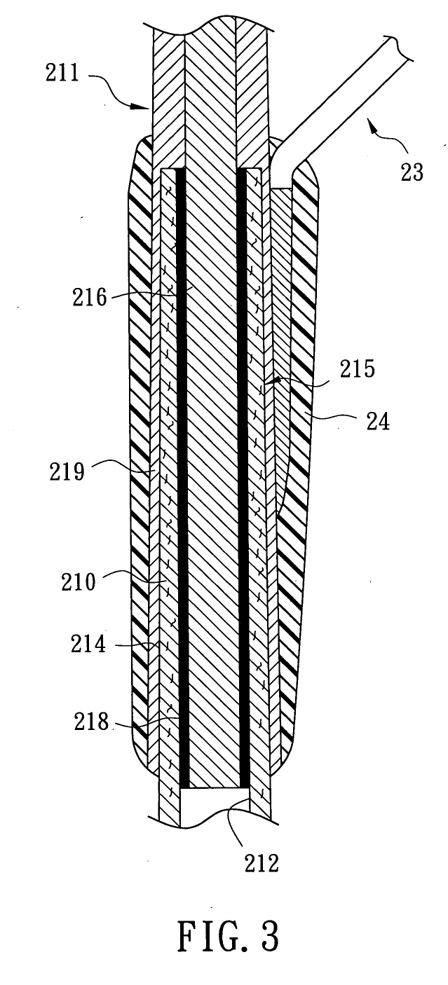

As shown in FIG. 3, the second preferred embodiment of a fishing rod 2 according to the present invention differs from the first preferred embodiment only in that the web 219 of the tip section 211 is also wound around the outer surface 214 of the butt section 210 at the end portion 215, such that, in the end portion 215 of the butt section 210, the web 219 is partially disposed between the butt section 210 and the line guide 23 and partially disposed between the butt section 210 and the epoxy coating 24.

Since the web 219 is wound around a larger area in the second preferred embodiment, the juncture between the butt section 210 and the tip section 211 is further strengthened, and the bending smoothness at the juncture between the butt section 210 and the tip section 211 is also further improved.

While the present invention has been described in connection with what is considered the most practical and preferred embodiments, it is understood that this invention is not limited to the disclosed embodiments but is intended to cover various arrangements included within the spirit and scope of the broadest interpretation as to encompass all such modifications and equivalent arrangements.

What is claimed is:

1. A fishing rod comprising:
a hollow butt section having an inner surface that defines an inner space; and
a solid tip section having an inner segment that extends into said inner space and that is bonded adhesively to said inner surface of said butt section, and an outer segment that extends from said inner segment and that is disposed outwardly of said inner space.

2. The fishing rod as claimed in claim 1, further comprising a web wound around said outer segment of said tip section.

3. The fishing rod as claimed in claim 1, wherein said butt section further has an outer surface and an end portion that is disposed adjacent to said tip section, said fishing rod further comprising a web wound around said outer segment of said tip section and said outer surface of said butt section at said end portion of said butt section.

4. The fishing rod as claimed in claim 1, wherein said tip section is made from a titanium alloy.

5. The fishing rod as claimed in claim 2, wherein said web is made from a composite fiber.

6. The fishing rod as claimed in claim 2, further comprising an epoxy coating that is bonded to said butt section and said web at a juncture between said butt section and said web.
